(19) United States
(12) Patent Application Publication
(10) Pub. No.: US 2010/0162113 A1
(43) Pub. Date: Jun. 24, 2010

(54) OPERATION SUPPORT SYSTEM, OPERATION SUPPORT METHOD, AND OPERATION SUPPORT PROGRAM

(76) Inventor: TERUAKI SASOU, Tokyo (JP)

Correspondence Address: Mr. Jackson Chen, 6535 N. STATE HWY 161, IRVING, TX, 75039, US

(21) Appl. No.: 12/628,362

(22) Filed: Dec. 1, 2009

(30) Foreign Application Priority Data
Dec. 22, 2008 (JP) 2008-325782

(51) Int. Cl. G06F 3/048; G06N 5/02

(52) U.S. Cl. 715/709; 706/47; 715/738

(57) ABSTRACT

To provide an operation support system and the like, which make it possible to share the information that can support operations of a user regarding the operation procedures of GUI input elements. The operation support system includes: an operation content recording control device which acquires operation content of the user executed on an operation screen of a user terminal that includes a plurality of GUI (Graphic User Interface) input elements for operating an input processing system, and records it as an operation log; an additional information managing device which records additional information data that corresponds to a specific operation order of the plurality of GUI input elements for the operation content recorded in the operation log; and an operation log display control device which displays the operation log together with the additional information on the user terminal.

### CROSS-REFERENCE TO RELATED APPLICATION

This application is based upon and claims the benefit of priority from Japanese patent application No. 2008-325782, filed on Dec. 22, 2008, the disclosure of which is incorporated herein in its entirety by reference.

### BACKGROUND OF THE INVENTION

1. Field of the Invention

The present invention relates to operation support for users who operate an input processing system utilizing WWW (World Wide Web). More specifically, the present invention relates to an operation support system which displays operation procedures and additional information for the operation procedures, and to an operation support method as well as an operation support program.

2. Description of the Related Art

It has been a while since input processing systems utilizing WWW such as work systems have come to be used in normal business works at companies. However, the input processing systems used for normal business works need to eliminate bugs very carefully. Also, it is necessary to share the operation procedures among the users in a strict manner.

However, even if the operation of the input processing system can be done by utilizing GUI (Graphic User Interface), the operation procedures of the system are often shared in natural languages. Thus, it is difficult for the operation procedures to be transferred accurately, so that communication loss may occur. Further, when a bug is discovered for a specific operation of the system, a large communication loss occurs when the symptom and the condition where the symptom is generated are transferred in a natural language.

In order to improve such state and make it easier to transfer the operation procedures, there are following techniques. Japanese Unexamined Patent Publication 2003-196243 (Patent Document 1) discloses a user-state display program which is capable of setting a user action rule and conditions for receiving the rule. Japanese Unexamined Patent Publication 2004-252515 (Patent Document 2) discloses a technique which customizes electronic manual contents and notes in accordance with the comprehension degrees of the users. Japanese Unexamined Patent Publication 2008-123379 (Patent Document 3) discloses a technique which collects and acquires operation histories of the users. Japanese Patent No. 3704871 (Patent Document 4) discloses a technique which acquires operations of the users set in a setting table, and saves those as logs.

Even in the input processing system that needs to eliminate the bags very carefully, it is difficult to deal with all the possible troubles in advance before the system starts the operations. However, after starting the system, users who do not have a high skill in terms of the operation procedures of the system may often use the system. Therefore, communication losses that are caused because the operation procedures are hard to be transferred accurately are more likely to occur.

When a measure taken for the trouble generated after starting the system is late, more costs are required for that. Thus, it is necessary to reduce such communication losses as much as possible. This can be said not only for the occurrence of the troubles but also for giving instructions of normal operation methods.

In a system using GUI in particular, it is essential to specify the operation procedure of GUI input elements when the user specifies and stores the own operation. However, Patent Documents 1-4 described above do not mention about any means for specifying and recording the operation procedures of each of the GUI input elements. Therefore, it is not possible with Patent Document 1-4 to overcome the aforementioned issues.

### SUMMARY OF THE INVENTION

It is therefore an exemplary object of the present invention to provide an operation support system, an operation support method, and an operation support program, which are capable of recording and sharing the information that can support the operation of the user regarding the operation procedure of the GUI input elements in the input processing system that utilizes GUI.

In order to achieve the foregoing exemplary object, the operation support system according to an exemplary aspect of the invention is a system for supporting an operation of a user, which is provided along with an input processing system which processes inputs from the user transmitted from a user terminal. The operation support system includes: an operation content recording control device which acquires an operation content of the user performed on an operation screen of the user terminal having a plurality of GUI (Graphic User Interface) input elements for operating the input processing system, and records the acquired operation content as an operation log; an additional information recording control device which records additional information corresponding to a specific operation order of the plurality of GUI input elements regarding the operation content recorded to the operation log; and an operation log display control device which displays the operation log together with the additional information on the user terminal.

In order to achieve the foregoing exemplary object, the operation support method according to another exemplary aspect of the invention is a method with which an operation support system provided along with an input processing system which processes inputs from the user transmitted from a user terminal supports an operation of the user. The operation support method includes: acquiring an operation content of the user performed on an operation screen of the user terminal having a plurality of GUI (Graphic User Interface) input elements for operating the input processing system, and recording the acquired operation content as an operation log by using an operation content recording control device; recording additional information corresponding to a specific operation order of the plurality of GUI input elements regarding the operation content recorded to the operation log by using an additional information recording control device; and displaying the operation log together with the additional information on the user terminal by using an operation log display control device.

In order to achieve the foregoing exemplary object, the operation support program according to still another exemplary aspect of the invention is a program for an operation support system for supporting an operation of a user, which is provided along with an input processing system which processes inputs from the user transmitted from a user terminal. The operation support program causes a computer to execute: a function which acquires an operation content of the user performed on an operation screen of the user terminal having a plurality of GUI (Graphic User Interface) input elements for operating the input processing system, and records the acquired operation content as an operation log; a function which records additional information corresponding to a specific operation order of the plurality of GUI input elements regarding the operation content recorded to the operation log; and a function which displays the operation log together with the additional information on the user terminal.

### BRIEF DESCRIPTION OF THE DRAWINGS

FIG. 1 is an explanatory diagram showing a structure of an operation support system according to a first exemplary embodiment of the present invention;

FIG. 2 is a flowchart showing normal actions of the operation support system shown in FIG. 1;

FIG. 3 is an explanatory diagram showing an example of an operation screen which accepts operations of a user, which is formed on a display by an input processing system shown in FIG. 1;

FIG. 4 is an explanatory diagram showing an example of contents of a log output rule shown in FIG. 1;

FIG. 5 is an explanatory diagram showing an example of contents of an operation log shown in FIG. 1;

FIG. 6 is a flowchart showing actions of an action information referring and updating section shown in FIG. 1;

FIG. 7 is an example of a display screen of an operation log displayed on the display by the actions shown in FIG. 6;

FIG. 8 is an explanatory diagram showing an example of additional information data that is inputted by a user in step S406 of FIG. 6;

FIG. 9 is a display example displayed on the operation screen shown in FIG. 3, on which an operation name, a notice point, and an operation order are superimposed;

FIG. 10 is an example of a final operation log display screen which is obtained from the operation log shown in FIG. 5 by executing the processing of steps S403-S404; and

FIG. 11 is an explanatory diagram showing a structure of an operation support system according to a second exemplary embodiment of the present invention.

### DETAILED DESCRIPTION OF THE EXEMPLARY EMBODIMENTS

### First Exemplary Embodiment

Hereinafter, the structure of a first exemplary embodiment of the present invention will be described by referring to the accompanying drawings.

At first, the basic contents of this exemplary embodiment will be described, and more specific contents will be described later.

An operation support system 1 according to the exemplary embodiment is an operation support system which supports operations conducted from a user terminal to an input processing system 20. The operation support system 1 includes: an operation content recording control device (log output control device 23) which acquires operation contents of the user for an operation screen 300 on a user terminal 10 that includes a plurality of. GUI (Graphic User Interface) input elements for operating the input processing system, and records those as an operation log 111; an additional information managing device 42 which records additional information data 113 that corresponds to specific operation procedures of the plurality of GUI input elements for the operation contents recorded in the operation log 111; and an operation log display control device (additional information display control device 53) which displays the operation log 111 together with the additional information 113 on the user terminal.

Note here that the operation support system 1 includes a rule reading control device 22 which reads the log output rule 112 that defines in advance the operation content as a target of recording to the operation log among the operations of the user conducted on the plurality of GUI input elements. The operation content recording control device (log output control device 23) records the operation of the user defined by the log output rule 112 to the operation log.

Further, the operation log display control device (additional information display control device 53) displays the recorded content containing the additional information data 113 in the operation log 111 by a display method that is different from a normal method. Further, the operation log display control device (additional information display control device 53) additionally displays the operation order corresponding to the additional information data 113 on the operation screen 300.

Furthermore, there are a plurality of user terminals 10 in the operation support system 1, and it is possible with the operation support system 1 to record and edit the additional information data 113 from each of the plurality of user terminals 10.

Through having this structure, this exemplary embodiment can effectively record and share the information that can support the operation of the user regarding the operation procedure of the GUI input elements.

This will be described in more details hereinafter.

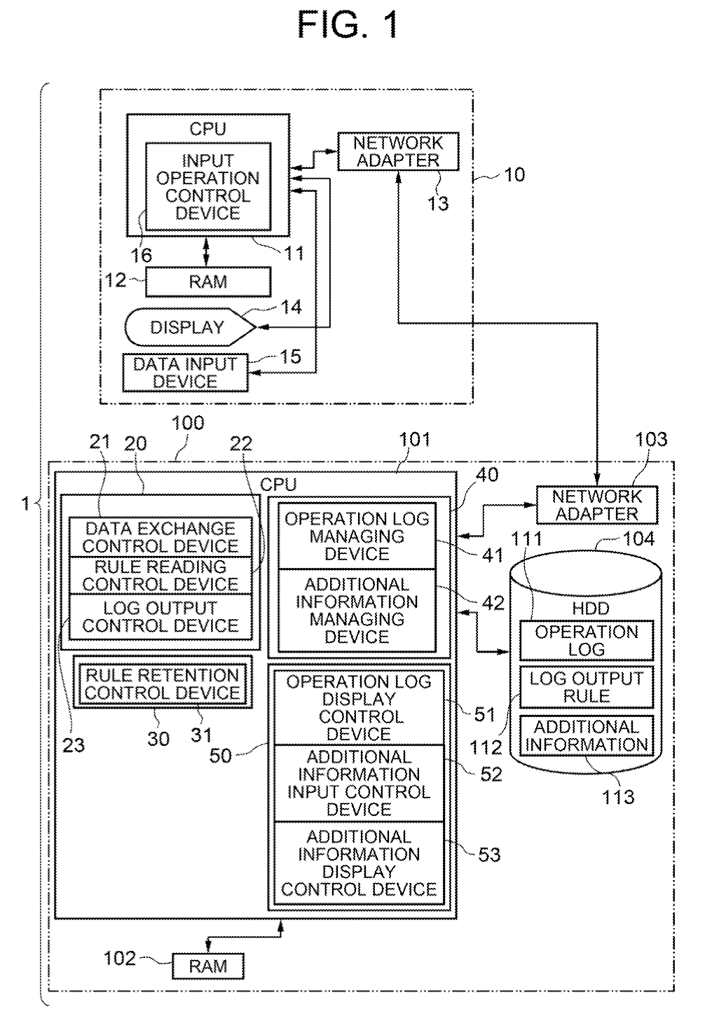

FIG. 1 is an explanatory diagram showing the structure of the operation support system 1 according to the first exemplary embodiment of the present invention. The operation support system 1 includes the user terminals 10 as computers operated by users and at least one server computer 100. The server computer 100 executes a program by a CPU to implement, on software, the input processing system 20 which processes requests from the users transmitted from the user terminals 10, a rule defining section 30 which defines the operation contents transmitted from the user terminals 10 to the input processing system 20, an action meta information storage section 40 which keeps the log outputted from the input processing system and the additional information for the log, and an action information referring and updating section 50 which enables the users to refer to and update the action log of the system.

Each of the elements shown in FIG. 1 other than the user terminal 10, i.e., the input processing system 20, the rule defining section 30, the action meta information storage section 40, and the action information referring and updating section 50, may be operated on a same computer or may physically be operated on different computers if data can be exchanged mutually. In order to simplify the explanations, it is assumed in this case that the input processing system 20, the rule defining section 30, the action meta information storage section 40, and the action information referring and updating section 50 are operated on the same server computer 100.

Note here that while only one each of the server computer 100 and the user terminal 10 is illustrated in FIG. 1, there may be a plurality of user terminals 10 for a single server computer 100 in practice.

The user terminal 10 includes: a CPU (Central Processing Unit) 11 as a main body which executes computer programs; a RAM (Random Access Memory) 12 as a main storage unit for storing programs that are executed by the CPU 11; a network adapter 13 which connects to other computers to perform data communications; a display 14 which forms a screen that can be operated by the user; and a data input device 15 which accepts the operation of the user.

Further, the input operation control device 16 forms the screen operable by the user on the display 14 according to an instruction from the input processing system 20, and transmits, to the input processing system 20, the operation data that is inputted by the user on the screen by operating the data input device 15 via the network adapter 13. More specifically, an application such as a web browser can be used as the input operation control device 16.

Like the user terminal 10, the server computer 100 includes a CPU 101, a RAM 102, and a network adapter 103. Functions of those are the same as the functions of the same elements in the user terminal 10. In addition to those, the server computer 100 includes an HDD (Hard Disk Drive) 104 that is a nonvolatile storage unit for keeping a large amount of data. The operation log 111, the log output rule 112, and the additional information data 113 are stored in the HDD 104. Details of each of those elements will be described later.

The input processing system 20, the rule defining section 30, the action meta information storage section 40, and the action information referring and updating section 50 are implemented on software by having the CPU 101 execute the programs. Operations of those are performed by corresponding to the operation data of the user received from the user terminal 10 via the network adapter 103, and the result of the execution is transmitted to the user terminal 10 via the network adapter 103.

The input processing system 20 is a system which processes requests of the user, such as a work system. The input processing system 20 includes: a data exchange control device 21 which exchanges the data on the operation screen displayed on the display 14 and the operation data of the user for the operation screen with the user terminal 10; a rule reading control device 22 which reads the log output rule 112; and a log output control device 23 which outputs the operation data of the user to the HDD 104 as the operation log 111. The data exchange control device 21 is provided conventionally to the input processing system 20, while the rule reading control device 22 and the log output control device 23 are provided additionally for implementing the present invention.

The rule defining section 30 includes a rule retention control device 31 which retains and manages, within the HDD 104, the log output rule 112 which is the data for defining the operation as the recording target as the operation log 111 from the operation data of the user.

The action meta information storage section 40 includes: an operation log managing device 41 which retains and manages the data of the operation log 111 within the HDD 104; and an additional information managing device 42 which retains and manages the additional information data 113 that is the additional data for the operation log 111 within the HDD 104.

The action information referring and updating section 50 includes: an operation log display control device 51 which transmits the content of the operation log 111 to the user terminal 10 to have it displayed; an additional information input control device 52 which makes the user terminal 10 display the screen to which the user can input the additional information data 113 for the content of the operation log 111; and an additional information display control device 53 which makes the user terminal 10 display the operation log 111 and the content of the inputted additional information data 113 in combination. The rule defining section 30, the action meta information storage section 40, and the action information referring and updating section 50 described above are all provided additionally for the present invention.

### Recording of Operation Log

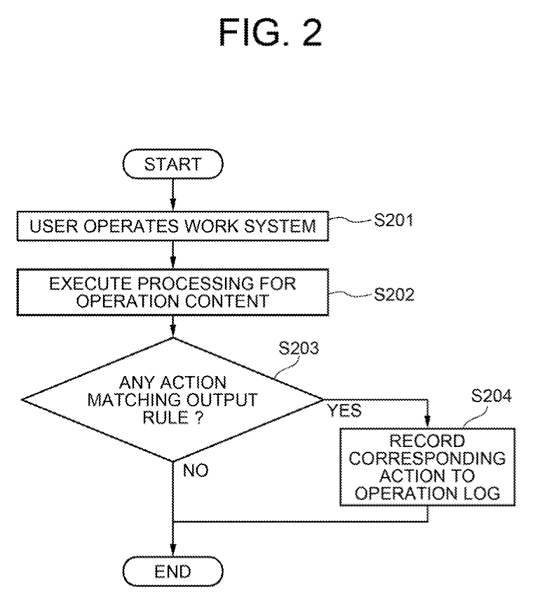

FIG. 2 is a flowchart showing normal actions of the operation support system 1 shown in FIG. 1. In a case where the user uses the operation support system 1, first, the user operates the input operation control device 16 to transmit the operation data to the input processing system 20 (step S201). The input processing system 20 executes the primary operating function of the system itself for the operation data received at the data exchange control device 21 (step S202). In the meantime, the input processing system 20 refers to the log output rule 112 read by the rule reading control device 22, and the log output control device 23 outputs the operation defined in the log output rule 112 among the operation data to the operation log managing device 41 to have it recorded in the operation log 111 (step S203-S204).

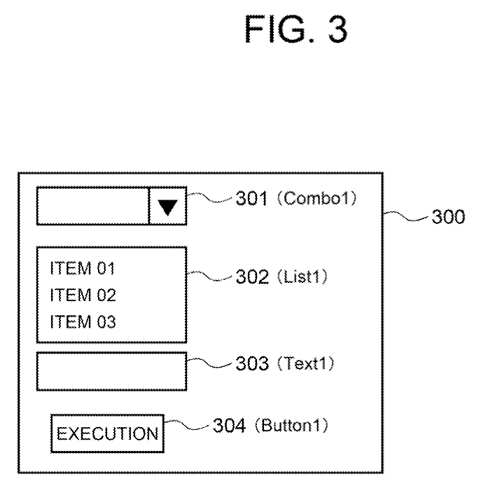

FIG. 3 is an explanatory diagram showing an example of the operation screen 300 that is formed on the display 14 by the input processing system 20 shown in FIG. 1 for accepting the operations of the user. In the example shown in FIG. 3, GUI input elements such as a combo box 301, a list box 302, a text box 303, a button 304 are arranged on the operation screen 300. Each of those GUI input elements has ID that can uniquely identify each element. In this case, it is assumed that ID “Combo1” is applied to the combo box 301, ID “List 1” to the list box 302, ID “Text1” to the text box 303, and ID “Button1” to the button box 304, respectively.

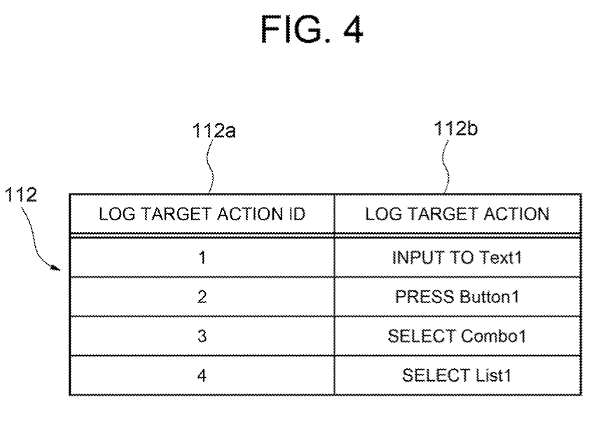

FIG. 4 is an explanatory diagram showing an example of the contents of the log output rule 112 shown in FIG. 1. The output log rule 112 includes: a log target action 112b which shows the target and kind of action that is the target to be recorded as the operation log 111; and a log target action ID 112a which is an ID that is allotted uniquely to the log target action 112b.

For example, the log target action 112b for the log target action ID 112a=“1” is defined as “input for the text box 303 (Text1)” on the operation screen 300 shown in FIG. 3. Similarly, the log target action 112b corresponding to the log target action ID 112a=“2” is designated in the log output rule 112 as “press the button box 304 (Button1)”, the log target action 112b corresponding to the log target action ID 112a=“3” as “select the combo box 301 (Combo1)”, and the log target action 112b corresponding to the log target action ID 112a=“4” as “select the list box 302 (List1)”, respectively. Operations to the GUI input elements not corresponding to the rule and the GUI elements which correspond to the rule but are actions not designated by the log target action 112b are not recorded as the operation log 111.

The rule reading control device 22 compares the log output rule 12 with the operation data that is received at the data exchange control device 21 from the input operation control device 16. When the operation data matches with the action defined in the log target action 112b, the rule reading control device 22 gives the corresponding log target action ID 112a to the operation data, and has it recorded to the operation log 111 along with the execution time thereof via the operation log managing device 41 (FIG. 2: steps S203-S204).

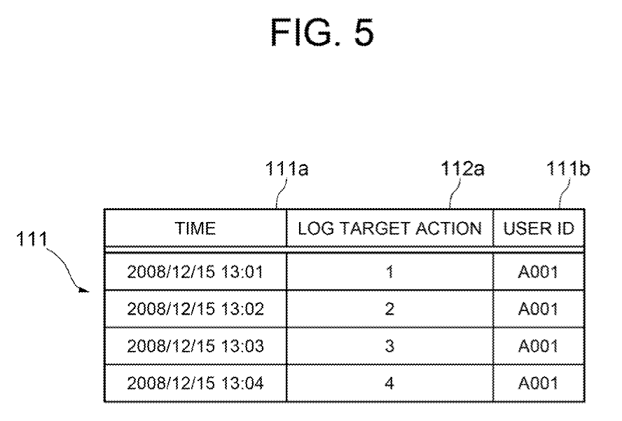

FIG. 5 is an explanatory diagram showing an example of the content of the operation log 111 shown in FIG. 1. As described above, the operation log managing device 41 records the log target action ID 112a, the executed time 111a, and the user ID 111b that is the ID of the user operating the user terminal 10 to the operation log 111 in a corresponding manner. In this exemplary embodiment, it is supposed that the user essentially logs in by inputting the user ID 111b when using the input processing system 20, so that the user ID 111b of the user who is currently operating the user terminal 10 is made clear for all the actions to be recorded. In the case shown in FIG. 5, the user having the user ID 111b=“A001” is operating the user terminal 10.

When there is a trouble generated in the input processing system 20, the user can call the action information referring and updating section 50 via the input control device 16 and refer to the action information. Further, when there is a function the user does not know, the user can also call the action information referring and updating section 50 and refer to the action information in the same manner. The action information referring and updating section 50 can help the user understand the function by displaying the operation log 111 and the content of the inputted additional information 113 in combination on the user terminal 10.

### Display and Recording of Additional Information

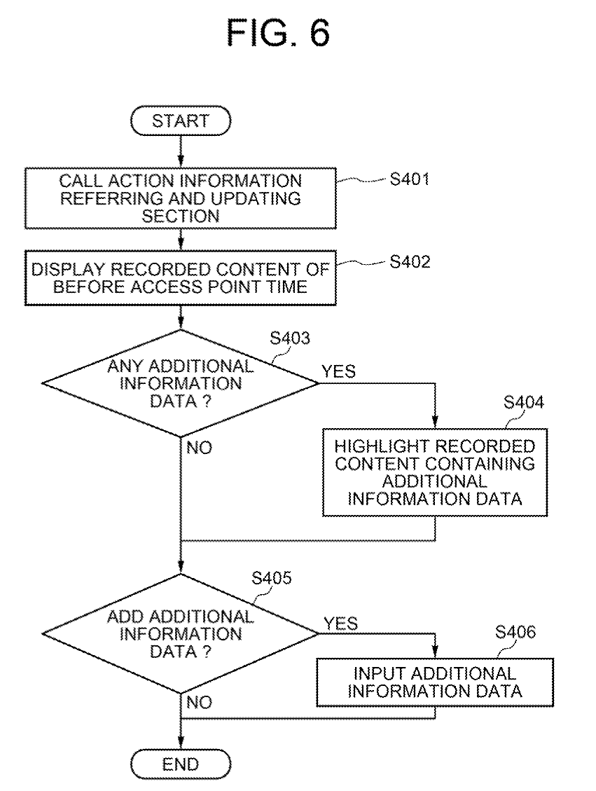

FIG. 6 is a flowchart showing actions of the action information referring and updating section 50 shown in FIG. 1. The user makes an access to the action information referring and updating section 50 at a timing when there is a trouble generated while using the system or when the user desires to refer to the use method (step S401). The operation log display control device 51 compares the time at the point where step S401 is executed (referred to as access time point hereinafter) with the time 111a recorded to the operation log 111, and displays the recorded content of before the access time point on the display 14 (step S402).

The additional information display control device 53 reads the additional information data 113, and displays the recording content that contains the additional information data 113 corresponding to the log target action ID 112a by a display method different from the normal method, e.g., by changing the color or changing the font (steps S403-S404).

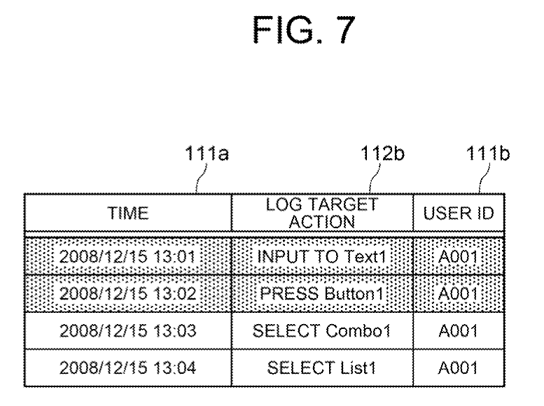

FIG. 7 is an example of the display screen of the operation log 111 that is displayed on the display 14 by the actions shown in FIG. 6. In FIG. 7, the lines which contain the additional information data 113 and are the targets to be displayed with highlight in steps S403-S404 are shown with shading. Further, in FIG. 7, the log target action ID 112a recorded in the operation log 111 is displayed by being replaced with the log target action 112b so that the user can see and easily understand the operation contents.

The user can not only see the display of the operation log 111 by the operation log display control device 51 but also can add information regarding the operation method of the input processing system 20 and the trouble dealing method on the display screen as the additional information data 113. This action will be described in detail.

Now, returning to FIG. 6, in a case where the user further adds the additional information data 113, the user performs an operation for adding the additional information data 113 on the display screen of the operation log display control device 51 (step S405). The operation executed in step S405 is an operation of a specific button or a menu bar, for example.

Upon detecting the operation, the operation log display control device 51 calls the additional information input control device 52 and accepts the input of the additional information data 113 from the user (step S406).

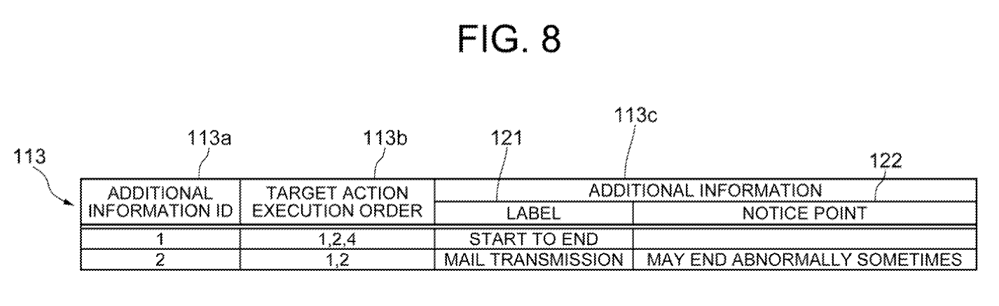

FIG. 8 is an explanatory diagram showing an example of the additional information data 113 that is inputted from the user in step S406 shown in FIG. 6. The additional information data 113 is configured with: an additional information ID 113a that can uniquely identify each piece of the additional information data; a target action execution order 113b in which the operation as the target of the additional data 113 and the order thereof are expressed with the log target action ID 112a; and additional information 113c named to the target action execution order 113b.

The user that has performed the operation for adding the additional information data 113 in step S405 can define the target action execution order 113b for all the GUI input elements on the operation screen 300 and also can define the additional information 113c for the defined target action execution order 113b. The additional information 113c herein may be a character string, a still picture, a moving picture, or the like, and the details thereof will be described later.

In the example shown in FIG. 8, in a case where the additional information ID 113a is “1” and the target action execution order 113b is “1, 2, 4”, operations to be executed are “input to the text box 303 (Text1)”, “press the button 304 (Button1)”, and then “select the combo box 301 (Combo1)”. The additional information 113c labeled as “from start to end” is defined for the series of operations.

Further, in a case where the additional information ID 113a is “2”, the additional information 113c is defined for a series of operations such as “input to the text box 303 (Text1)”, and then “press the button 304 (Button1)”. As in these cases, the user can define the additional information 113c for each of the actions expressed with the orders of the log target action IDs 112a.

The additional information 113c in the example of FIG. 8 is configured with a label 121 that is the name given to each operation, and a notice point 122 for the operation defined by the label 121. It is possible to give a name such as “mail transmission” as the label 121 for the operations of “input to the text box 303 (Text1)” and “press the button 304 (Button1)”.

Therefore, the user who does not know how to operate the system to perform “mail transmission” can obtain the order of operation shown with the target action execution order 113b from the label 121 that corresponds to the keyword “mail transmission” by seeing the information. Further, the notice point 122 “may end abnormally sometimes” is recorded for the operation defined by the label 121 “mail transmission”. Thereby, the user, the developer, and the like can deal with the content depicted in the notice point 122 adequately.

Further, the additional information 113c is not limited to the label 121 and the notice point 122. For example, the additional information 113c may include others such as a character string, a still picture or a moving picture showing the state of the operation.

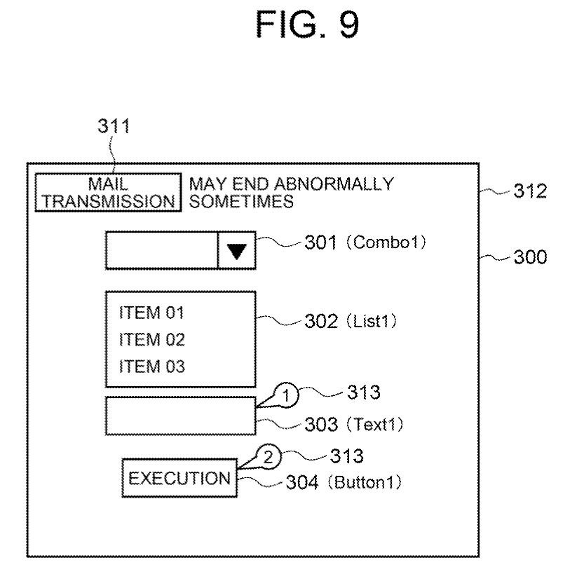

Further, it is also possible with the additional information display control device 53 to display, with highlight, the GUI input elements corresponding to the target action execution order 113b, i.e., the text box 303 (Text1) and the button 309 (Button1) in this case, on the actual operation screen 300 that is displayed by the input processing system 20. FIG. 9 is a display example in which an operation name 311, i.e., “mail transmission” which is defined in the label 121, a notice point 312 regarding the operation written in the notice point 122, and an operation order 313 defined in the target action execution order 113b are displayed in an superimposed manner.

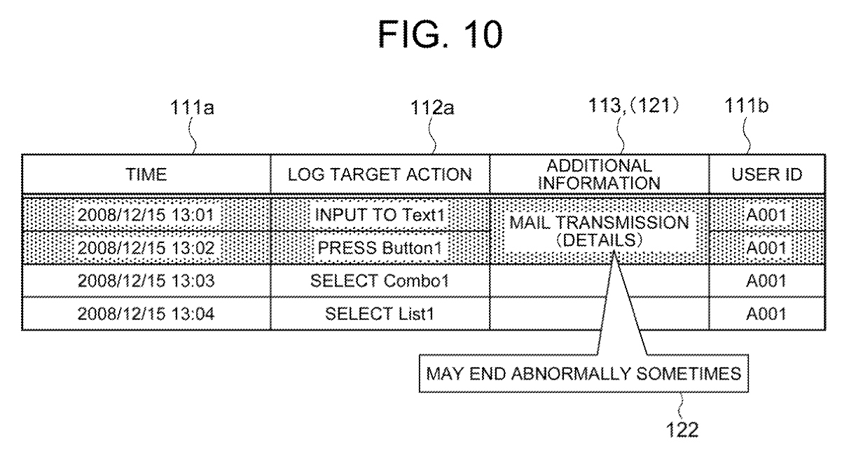

The operations including such additional information data 113 among the operations by the user recorded in the operation log 111 are displayed conspicuously on the display screen of the operation log 111 through executing steps S403-S404 shown in FIG. 6. FIG. 10 is an example of the display screen of the final operation log 111 that is obtained from the operation log 111 shown in FIG. 5 through executing steps S403-S404.

In the case of FIG. 10, the two rows including the additional information 113c of “mail transmission” are displayed with shading through the above-described steps S403-S404. When a pointer of a mouse is placed on the rows shown with the shading, the notice point 122 is displayed in a balloon.

In that case, it is also possible to record the number of times (not shown) of updates of the data conducted by the input from the additional information input control device 52 among the additional information data 113 shown in FIG. 9, and to preferentially display the data whose update number of times is the greatest. Further, on the display screen shown in FIG. 9, only a specific number of continuing actions or more can be taken as the targets to display the existence of the additional information data 113.

### Overall Actions of First Exemplary Embodiment

Next, the overall actions of the above-described exemplary embodiment will be described. The actions according to the exemplary embodiment is an operation support method with which an operation support system provided along with the input processing system supports the operations from the user terminal conducted on the operation support system, in which: the operation content recording control device acquires the operation content of the user conducted on the operation screen on the user terminal which includes a plurality of GUI (Graphic User Interface) input elements for operating the input processing system (FIG. 2: step S203); the operation content recording control device records the operation content as the operation log (FIG. 2: step S204); the additional information recording control device records the additional information corresponding to a specific operation order for the plurality of GUI input elements for the operation content recorded in the operation log (FIG. 4: steps S405-S406); and the operation log display control device displays the operation log in combination with the additional information on the user terminal (FIG. 4: steps S403-S404).

Each of the action steps described above may be put into a program that can be executed in a computer to have it executed in the server computer 100 that is a computer which directly executes each of the steps.

Through such actions, the exemplary embodiment can provide following effects.

In this exemplary embodiment, the additional information data 113 corresponding to the specific operation order of the plurality of GUI input elements is recorded and displayed by the action information referring and updating section 50 in the input processing system 20. Therefore, the user can easily specify and memorize the own operations with the display contents and to easily transfer the actions to the others.

Note here that while only one each of the server computer 100 and the user terminal 10 is illustrated in FIG. 1, there exist a plurality of user terminals 10 for a single server computer 100 in practice, and there are also a plurality of users which utilize the input processing system 20 from those user terminals 10.

Therefore, when one of the plurality of users inputs the additional information 113c, all the users of the input processing system 20 can refer to the additional information 113c. The additional information 113c that is once inputted by a given user can also have an addition or can be revised by other users. This makes it possible for all the users of the system to share the useful information for the actions and operations of the input processing system 20.

As an exemplary advantage according to the invention, the present invention is structured to record and display the additional information corresponding to the specific operation order for the plurality of GUI input elements as described above. Therefore, the user can easily specify and memorize the own operation with the content of the display. This makes it possible to record and share the information that can support the operation of the user regarding the operation procedure of the GUI input elements.

### Second Exemplary Embodiment

An operation support system 501 according to a second exemplary embodiment of the present invention mostly has the same structural elements as the operation support system 1 according to the first exemplary embodiment. The difference with respect to the first exemplary embodiment is a request monitoring section 70 as an operation content recording control device acquires the operation content of the user from a proxy server on which an HTTP proxy is operated.

This will be described in more details hereinafter.

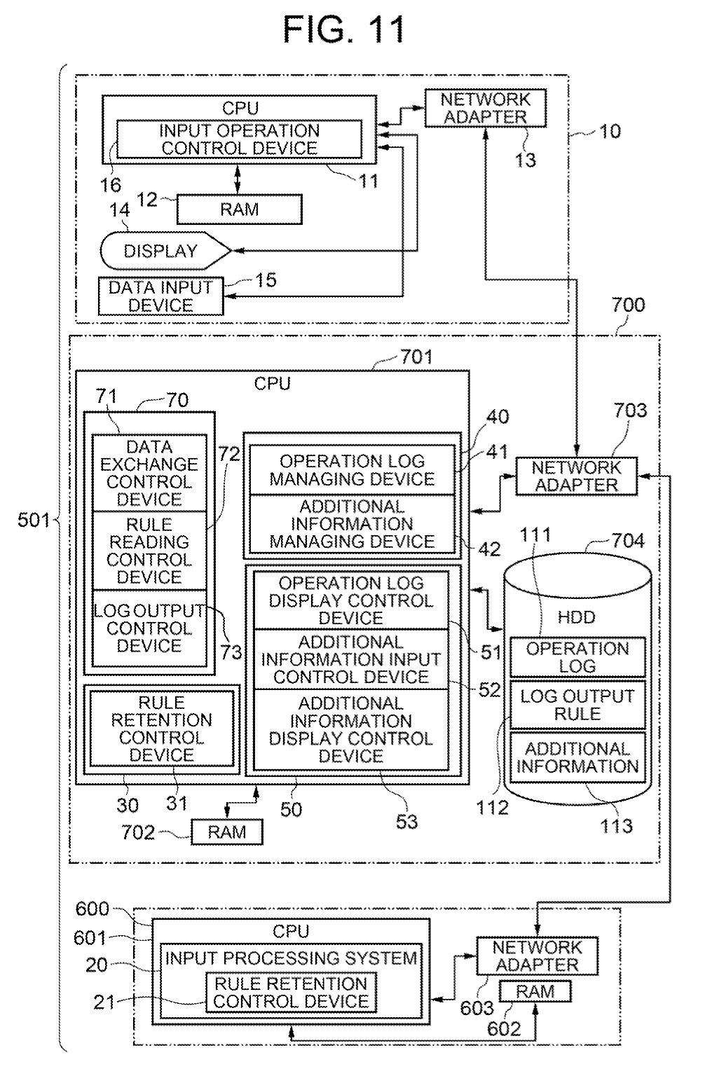

FIG. 11 is an explanatory diagram showing the structure of the operation support system 501 according to the second exemplary embodiment of the present invention. In the operation support system 1 according to the first exemplary embodiment described above, the input processing system 20, the rule defining section 30, the action meta information storage section 40, and the action information referring and updating section 50 are all implemented by the same server computer 100. However, in the second exemplary embodiment, the input processing system 20 is implemented by a server computer 600, and the rule defining section 30, the action meta information storage section 40, and the action information referring and updating section 50 are operated on a proxy server 700 which is a computer other than the server computer 600. Further, in the proxy server 700, the request monitoring section 70 to be described later is also operated simultaneously with those structural elements.

As in the case of the server computer 100 of the first exemplary embodiment, the server computer 600 includes a CPU 601, a RAM 602, and a network adapter 603. The input processing system 20 is executed by the CPU 601 as a computer program. The input processing system 20 operated by the server computer 600 is an already existing type, so that it only includes the data exchange control device 21 which exchanges data with the user terminals 10. The rule reading control device 22 and the log output control device 23 provided in the above-described first exemplary embodiment are not provided to this input processing system 20.

The proxy server 700 is a computer unit provided between the user terminal 10 and the server computer 600, on which the rule defining section 30, the action meta information storage section 40, the action information referring and updating section 50 as well as the request monitoring section 70 for acquiring the operation contents from the user terminal 10 for the input processing system 20 are operated.

As in the case of the server computer 100 of the first exemplary embodiment, the proxy server 700 includes a CPU 701, a RAM 702, a network adapter 703, and an HDD 704. Functions of those are the same as those of the same structural elements of the server computer 100. The rule defining section 30, the action meta information storage section 40, the action information referring and updating section 50, and the request monitoring section 70 are executed as respective computer programs by the CPU 701. The network adapter 703 is located in the intermediate point between the user terminal 10 and the server computer 600, thereby making it possible to obtain the communication contents between the user terminal 10 and the server computer 600.

The request monitoring section 70 includes: an operation acquisition control device 71 which acquires the contents of operation executed from the user terminal 10 to the input processing system 20 by the HTTP proxy defined as the standard in communications done by HTTP (Hypertext Transfer Protocol, RFC2616); and a rule reading control device 72 and a log output control device 73, which respectively perform same actions as the rule reading control device 22 and the log output control device 23 of the first exemplary embodiment for the operation contents of the user acquired by the operation acquisition control device 71.

Actions of the user terminal 10, the input processing system 20, the rule defining section 30, the action meta information storage section 40, and the action information referring and updating section 50 are the same as those of the first exemplary embodiment in principle. However, the input processing system 20 does not include the rule reading control device 22 and the log output control device 23. Instead, the rule reading control device 72 and the log output control device 73 included in the request monitoring section 70 have the same functions as those of the rule reading control device 22 and the log output control device 23 of the first exemplary embodiment, perform the same actions, and provide the same effects.

That is, the second exemplary embodiment is capable of achieving the same effects through the same actions as those of the first exemplary embodiment without applying any changes to the input processing system 20 and the server computer 600 on which the input processing system 20 is operated. The server computer 600 may be operated by a different organization from the organization to which the user terminal 10 and the proxy server 700 belong, for example, as long as it can be connected to the user terminal 10 via the Internet.

Further, the action of the request monitoring section 70 for acquiring the operation contents of the user terminal 10 executed to the input processing system 20 can be performed by the HTTP proxy defined ordinarily with standard HTTP protocol, so that it is unnecessary to apply any changes to the user terminal 10 side. The request monitoring section 70 may be operated on a computer that is capable of acquiring the operation contents of the user terminal 10 by the HTTP proxy. Further, the rule defining section 30, the action meta information storage section 40, the action information referring and updating section 50, and the request monitoring section 70 may be operated on physically separate computers as long as data can be exchanged mutually.

While the present invention has been described by referring to the specific exemplary embodiments shown in the accompanying drawings thereof, the present invention is not limited only to those exemplary embodiments. Any already-known structures can be employed therewith, as long as it is possible to achieve the effects of the present invention.

### INDUSTRIAL APPLICABILITY

The present invention can be applied to various kinds of usages such as creation of trouble dealing database for a web-based input processing system, creation of a manual database, creation of FAQ (Frequently Asked Questions), debugging, and the like.

What is claimed is:

1. An operation support system for supporting an operation of a user, which is provided along with an input processing system which processes inputs from the user transmitted from a user terminal, the operation support system comprising:
an operation content recording control device which acquires an operation content of the user performed on an operation screen of the user terminal having a plurality of GUI (Graphic User Interface) input elements for operating the input processing system, and records the acquired operation content as an operation log;
an additional information recording control device which records additional information corresponding to a specific operation order of the plurality of GUI input elements regarding the operation content recorded to the operation log; and
an operation log display control device which displays the operation log together with the additional information on the user terminal.

2. The operation support system as claimed in claim 1, comprising a rule reading control device which reads a log output rule that defines in advance an operation content as a recording target for the operation log among the operations of the user executed on the plurality of GUI input elements, wherein
the operation content recording control device performs a recording control of the operation of the user defined in the log output rule to the operation log.

3. The operation support system as claimed in claim 1, wherein the operation log display control device displays the recording content that contains the additional information in the operation log on the user terminal by a display method that is different from a normal display method.

4. The operation support system as claimed in claim 1, wherein the operation log display control device has an operation order corresponding to the additional information included in the operation screen to be displayed on the user terminal.

5. The operation support system as claimed in claim 1, wherein:
there are a plurality of the user terminals; and the additional information can be recorded and edited from each of the plurality of user terminals.

6. The operation support system as claimed in claim 1, wherein the operation content recording control device acquires the operation content of the user from a proxy server on which an HTTP (Hyper Text Transfer Protocol) proxy is operated.

7. An operation support method with which an operation support system provided along with an input processing system which processes inputs from the user transmitted from a user terminal supports an operation of the user, the operation support method comprising:
acquiring an operation content of the user performed on an operation screen of the user terminal having a plurality of GUI (Graphic User Interface) input elements for operating the input processing system, and recording the acquired operation content as an operation log by using an operation content recording control device;
recording additional information corresponding to a specific operation order of the plurality of GUI input elements regarding the operation content recorded to the operation log by using an additional information recording control device; and
displaying the operation log together with the additional information on the user terminal by using an operation log display control device.

8. A computer readable recording medium storing an operation support program for controlling support of an operation of a user, which is provided along with an input processing system which processes inputs from the user transmitted from a user terminal, the operation support program causing a computer to execute:
a function which acquires an operation content of the user performed on an operation screen of the user terminal having a plurality of GUI (Graphic User Interface) input elements for operating the input processing system, and records the acquired operation content as an operation log;
a function which records additional information corresponding to a specific operation order of the plurality of GUI input elements regarding the operation content recorded to the operation log; and
a function which displays the operation log together with the additional information on the user terminal.

9. An operation support system for supporting an operation of a user, which is provided along with an input processing system which processes inputs from the user transmitted from a user terminal, the operation support system comprising:
operation content recording control means for acquiring an operation content of the user performed on an operation screen of the user terminal having a plurality of GUI (Graphic User Interface) input elements for operating the input processing system, and recording the acquired operation content as an operation log;
additional information recording control means for recording additional information corresponding to a specific operation order of the plurality of GUI input elements regarding the operation content recorded to the operation log; and
operation log display control means for displaying the operation log together with the additional information on the user terminal.
